(19) United States
(12) Patent Application Publication
(10) Pub. No.: US 2008/0111343 A1
(43) Pub. Date: May 15, 2008

(54) Car-style steering system for a child's tricycle

(76) Inventor: Stanley Barcroft, Havant (GB)

Correspondence Address: MR. STANLEY BARCROFT, 1 ELDER ROAD, HAVANT, PO9 2UN, omitted

(21) Appl. No.: 11/906,042

(22) Filed: Oct. 1, 2007

(30) Foreign Application Priority Data
Nov. 15, 2006 (GB) 0622852.2

(51) Int. Cl. B62K 5/02

(52) U.S. Cl. 280/270

(57) ABSTRACT

A child's tricycle featuring a mechanical assembly which makes it easier to steer especially whilst pedaling, and also simulates the action of steering a car, through the incorporation of a small steering-wheel 2 and a gearbox 1 of approximately 8:1 velocity-reduction ratio.

The gearbox which is planetary in one or two stages can be mounted co-axially inside the headstock of a tricycle frame during manufacture, or alternatively provided as an “add-on” unit to be mounted co-axially above the headstock and locked to it to prevent rotation.

The steering-wheel can be fitted with a swivelling knob-like handle to facilitate wide-range rotation. The handle can be positioned to suit left or right-handed operation.

This invention relates to a child's tricycle of the general type having a frame, front forks connected to the frame for turning about a steering axis, a front wheel connected to the front forks for rotation about a front wheel axis, and pedals connected to the front wheel for rotation with the front wheel about the front wheel axis.

The tricycle is powered by the child alternately pressing on the pedals so as to turn the front wheel about its axis. A conventional tricycle of this type has handlebars connected to the forks, so that the child can steer the tricycle by turning the handlebars about the steering axis while they pedal along.

The forces applied by the child whilst pedaling produce not only a torque about the wheel axis to propel the tricycle, but also an oscillating torque about the steering axis. In order to resist this oscillating torque so that the tricycle does not follow an undulating path, the child needs to apply an equal and opposite oscillating torque to the handlebars. This can be tiring and also interfere with the task of steering.

The present invention is concerned with this problem and arose as a result of modifying a tricycle to enable it to be ridden by a three-year-old child born with only one arm.

In accordance with the present invention, the child's tricycle of the general type defined above is characterised by a steering wheel, and a gearbox connecting the steering wheel to the front forks to provide an angular velocity reduction ratio of approximately 8:1 from rotation of the steering wheel to turning of the front forks about the steering axis.

This makes it easier to steer the tricycle, especially whilst pedaling, and it also simulates the action of steering a car. Although the invention was conceived as a tricycle for a disabled child, it can also increase the enjoyment of other child riders who are not disabled.

Specific embodiments of the present invention will now be described, purely by way of example, with reference to the accompanying drawings, in which:

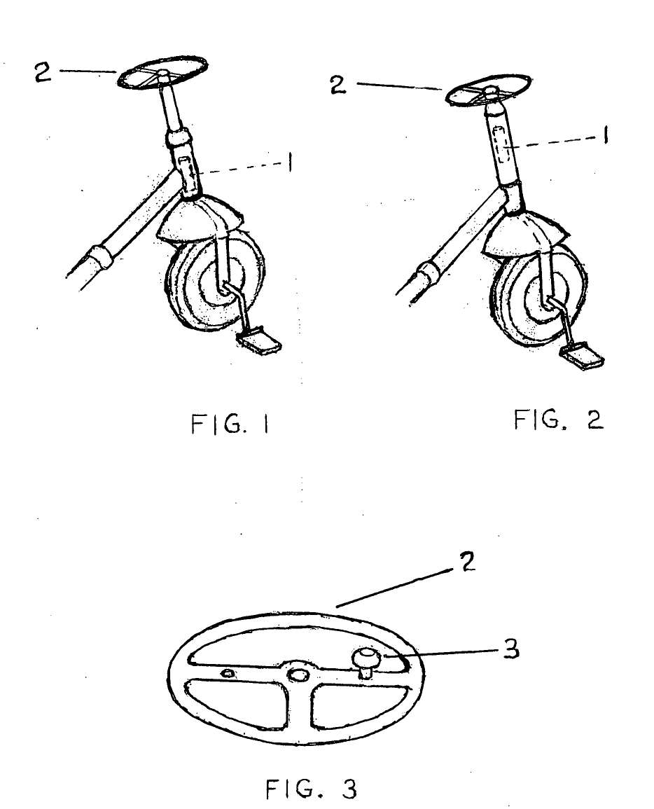

FIG. 1 shows a front half of a child's tricycle of one embodiment of the invention;

FIG. 2 shows a front half of a child's tricycle of another embodiment of the invention; and

FIG. 3 shows on a larger scale a steering wheel that may be used with the tricycles of FIGS. 1 and 2.

Referring to the drawings, a tricycle has a gearbox 1 with an upwardly extending input shaft connected to a steering wheel 2, and a downwardly extending output shaft connected to the front forks. The input and output shafts are coaxial. The gearbox 1 is of the planetary type with one or two stages. With two stages, each sun-gear can be made larger and therefore stronger in conjunction with its planet-gears and a common ring-gear.

As shown in FIG. 1, the gearbox 1 is mounted inside a headstock of the frame.

Alternatively, as shown in FIG. 2, the gearbox 1 is mounted above the headstock of the frame between an emerging handlebar stem and the steering wheel 2. This is particularly applicable when the gearbox 1 and steering wheel 2 are provided as an “add-on” unit. In this case, the ring-gear has a cylindrical housing body which is locked to the tricycle frame to prevent rotation.

As shown in FIG. 3, the steering wheel 2 has a swivelling actuating knob 3 shown positioned for right-handed operation, and the steering wheel 2 is formed with an alternative mounting position for the actuating knob 3 for left-handed operation.

I claim:

1. A child's tricycle having a frame, front forks connected to the frame for turning about a steering axis, a front wheel connected to the front forks for rotation about a front wheel axis, pedals connected to the front wheel for rotation with the front wheel about the front wheel axis, a steering wheel, and a gearbox connecting the steering wheel to the front forks to provide an angular velocity reduction ratio of approximately 8:1 from rotation of the steering wheel to turning of the front forks about the steering axis.

2. A tricycle as claimed in claim 1, wherein the gearbox has an upwardly extending input shaft connected to the steering wheel, and a downwardly extending output shaft connected to the front forks.

3. A tricycle as claimed in claim 2, wherein the input and output shafts are coaxial.

4. A tricycle as claimed in any preceding claim, wherein the gearbox is of the planetary type.

5. A tricycle as claimed in any preceding claim, wherein the gearbox is mounted inside a headstock of the frame.

6. A tricycle as claimed in any of claims 1 to 4, wherein the gearbox is mounted above a headstock of the frame.

7. A tricycle as claimed in any preceding claim, wherein the gearbox has a body fixed to the frame.

8. A tricycle as claimed in any preceding claim, wherein the steering wheel has a swivelling actuating knob.

9. A tricycle as claimed in claim 8, wherein the steering wheel is formed with an alternative mounting position for the actuating knob.

10. A child's tricycle substantially as described with reference to the drawings.
